(19) United States
(12) Patent Application Publication
(10) Pub. No.: US 2026/0350726 A1
(43) Pub. Date: Nov. 5, 2026

(54) BLOCKCHAIN-ENABLED MULTI-ENTITY ACCOUNT SETTLEMENT PROCESS AND SYSTEM THEREFOR

(71) Applicant: Dejan Petrovic, Hallandale Beach, FL (US)

(72) Inventor: Dejan Petrovic, Hallandale Beach, FL (US)

(21) Appl. No.: 19/196,009

(22) Filed: May 1, 2025

(51) Int. Cl. G06Q 50/18; G06Q 20/02; H04L 9/32

(52) U.S. Cl. CPC G06Q 50/182; G06Q 20/023; H04L 9/321

(57) ABSTRACT

A method for multi-entity account settlement using blockchain-enabled system is disclosed. The method includes receiving input data from participating entities. The method also includes encrypting input data and uploading encrypted data to blockchain network. The method includes performing on-chain aggregation and standardization of encrypted data to create verifiable ledger of inter-entity obligations. The method also includes initializing each entity and obligation as unmatched for first settlement cycle. The method further includes iteratively constructing settlement chains by selecting a first unmatched entity and an outgoing unmatched obligation; and extending the chain by continuously identifying and adding sequential unmatched obligations between selected entities until the chain is closed or finalized. The method includes determining minimum common settlement amount across all obligations and automatically executing settlement by reducing each obligation in chain by determined amount. The method further includes repeating steps from chain construction to settlement until no further chains can be formed.

### FIELD OF THE INVENTION

The present invention relates generally to the field of financial technology and more specifically, to a blockchain-enabled multi-entity account settlement process and a system therefor.

### BACKGROUND OF THE INVENTION

Conventional financial settlement methods include manual reconciliation processes, bilateral netting agreements between two parties, centralized clearing houses, and standard bank transfer systems (e.g., Automated Clearing House (ACH), wire transfers, SWIFT) for settling inter-company debts individually. While effective for basic transactions, these systems are complex, slow, and resource-intensive, particularly when involving multiple parties with intertwined receivables and payables. Conventional methods require actual capital movement, leading to transaction fees, settlement delays, and increased counterparty and banking system exposure. Manual reconciliation is slow, expensive, error-prone, and lacks scalability for complex multi-party scenarios. Some basic multi-party reconciliation software exists but typically requires manual intervention for complex chains and involves monetary settlement.

Some blockchain-based solutions, such as RippleNet and stablecoin platforms, have emerged to address certain inefficiencies, providing faster, borderless monetary transfers. However, these systems mainly focus on monetary transactions and lack settlement architectures capable of automating complex multilateral netting scenarios across multiple entities. These systems do not natively support indefinite settlement chain construction or automated matching based on minimum common settlement values in a privacy-preserving manner.

The prior-art reference Chinese Patent No. 110348979 discloses a method for automatically clearing multi-side credited liabilities by using a closed-loop data chain, forming settlement chains and using the minimum amount of debt as a common divisor. However, it does not disclose execution through smart contracts on a permissioned blockchain, nor the generation of legally binding settlement documents. The prior-art reference U.S. Patent Publication No. 20200167773 relates to real-time payments across linked multiple blockchain systems but lacks automated multilateral chain construction based on minimum settlement amounts. The prior-art reference U.S. Pat. No. 11,669,830 describes distributed ledger-based commodity settlement using smart contracts but focuses on bilateral commodity-cash exchanges rather than dynamic multilateral chain settlements. The prior-art reference Chinese Patent App. No. 119762069 discloses automatic settlement systems for merchants involving error checking and reconciliation but does not implement blockchain-based dynamic chain construction. The prior-art reference U.S. Pat. No. 11,188,907 focuses on ACH authorization validation using public blockchains, however it does not disclose multilateral netting. The prior-art reference U.S. Pat. No. 12,079,200 teaches blockchain audit and payment clearing for electronic trading systems but does not disclose iterative multilateral debt chain processing.

None of the known systems disclose or suggest an automated method for constructing indefinite, non-duplicating settlement chains across multiple entities, where the settlement amount is determined based on the minimum common relation amount, and the process is executed non-monetarily over a privacy-preserving, permissioned blockchain infrastructure. Moreover, automated generation of legally binding settlement documents that are hashed and recorded immutably on-chain is not taught by any cited prior art. Hence, there exists a need to provide a system and method for efficiently settling multilateral obligations across multiple entities in a secure, automated, and privacy-preserving manner, while also generating verifiable legal settlement records.

### SUMMARY OF THE INVENTION

It is an objective of the present invention to provide a system and method for automated, non-monetary settlement of multilateral obligations across multiple entities.

It is another objective of the present invention to construct indefinite, non-duplicating settlement chains based on minimum common settlement amounts.

It is yet another objective of the present invention to execute settlements securely over a privacy-preserving, permissioned blockchain infrastructure.

It is a further objective of the present invention to automatically generate legally binding settlement documents with verifiable blockchain-based auditability.

According to an embodiment of the present invention, a method for multi-entity account settlement using a blockchain-enabled system is disclosed. The method includes receiving input data from participating entities, the input data being accounts receivable and accounts payable data. The method also includes encrypting the input data using institutional encryption keys. The method further includes uploading the encrypted data to a permissioned blockchain network. The method includes performing on-chain aggregation and standardization of the encrypted data using smart contracts to create verifiable ledger of inter-entity obligations. The method also includes initializing each entity and obligation as unmatched for a first settlement cycle. The method further includes iteratively constructing settlement chains by selecting a first unmatched entity and an outgoing unmatched obligation; and extending the chain by continuously identifying and adding sequential unmatched obligations between selected entities until the chain is closed or finalized upon forming a complete settlement loop or reaching a terminal point, respectively. The method includes determining a minimum common settlement amount across all obligations within the constructed chain. The method also includes automatically executing settlement by reducing each obligation in the chain by the determined minimum common settlement amount via smart contracts. The method further includes repeating steps from settlement chain construction to settlement execution until no further chains can be formed.

According to another embodiment of the present invention a system comprising a processor and memory for multi-entity account settlement is disclosed, wherein the processor and memory in combination are operable to implement a method. The method includes receiving input data from participating entities, the input data being accounts receivable and accounts payable data. The method also includes encrypting the input data using institutional encryption keys. The method further includes uploading the encrypted data to a permissioned blockchain network. The method includes performing on-chain aggregation and standardization of the encrypted data using smart contracts to create verifiable ledger of inter-entity obligations. The method also includes initializing each entity and obligation as unmatched for a first settlement cycle. The method further includes iteratively constructing settlement chains by selecting a first unmatched entity and an outgoing unmatched obligation; and extending the chain by continuously identifying and adding sequential unmatched obligations between selected entities until the chain is closed or finalized upon forming a complete settlement loop or reaching a terminal point, respectively. The method includes determining a minimum common settlement amount across all obligations within the constructed chain. The method also includes automatically executing settlement by reducing each obligation in the chain by the determined minimum common settlement amount via smart contracts. The method further includes repeating steps from settlement chain construction to settlement execution until no further chains can be formed.

### BRIEF DESCRIPTION OF DRAWINGS

FIG. 1 is a high-level architecture of a blockchain-enabled system for automated multi-entity account settlement.

FIG. 2 is a flowchart illustrating a method for automated multi-entity account settlement using the blockchain-enabled system of FIG. 1.

FIG. 3 is a block diagram of a distributed computer system.

### DETAILED DESCRIPTION OF THE INVENTION

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention. For a more complete understanding of the present invention, reference is now made to the following descriptions taken in conjunction with the accompanying drawings.

The present invention disclosed herein is a blockchain-enabled system and method for automated multi-entity account settlement. The system enables a plurality of business entities to efficiently offset mutual accounts receivable and accounts payable through the creation and execution of non-monetary settlement chains. By automating the settlement process and eliminating the need for actual cash movement, the present invention reduces reliance on traditional banking transfers, minimizes transaction costs, improves financial key performance indicators (KPIs) such as days sales outstanding (DSO) and days payable outstanding (DPO), and enhances transactional privacy through the use of encryption and a permissioned blockchain infrastructure.

The present invention provides significant advantages over conventional settlement methods, including capital efficiency by freeing up working capital without requiring liquidity for cash settlements; reduced costs by eliminating wire transfer fees, bank charges, and manual reconciliation expenses; and enhanced speed and efficiency by automating complex settlement cycles. The system is capable of handling settlement chains involving a potentially unlimited number of entities without manual intervention. Privacy and confidentiality are preserved through institutional encryption of submitted data and controlled access within the permissioned blockchain network. The present invention also improves auditability and transparency by maintaining an immutable, verifiable ledger of all settlement actions, accessible to participants and regulatory bodies as needed, and reduces counterparty risk associated with traditional fund-based settlements.

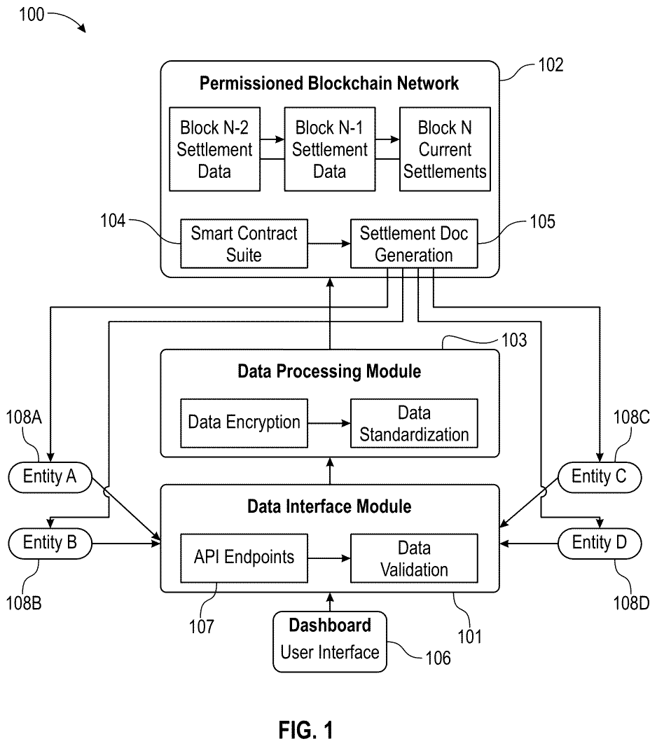

According to an exemplary embodiment of the present invention, a blockchain-based system for automated multi-entity account settlement is disclosed. A simplified architecture of the blockchain-based system 100 is illustrated in FIG. 1. The system 100 comprises a data interface module 101, a permissioned blockchain network 102, a data processing and encryption module 103, a smart contract suite 104, a settlement document generation module 105, and a user interface/dashboard module 106. In an embodiment, the data interface module 101 is configured to receive a plurality of financial data into the system 100. The data interface module 101 provides one or more application programming interfaces (APIs) and integration connectors 107 that enable a plurality of participating entities 108A, 108B, 108C, 108D to submit their accounts receivable and accounts payable information. In certain aspects, the data interface module 101 supports various data formats including but not limited to JSON, XML, and CSV to accommodate different accounting systems used by participant entities 108A, 108B, 108C, 108D.

In an embodiment, the permissioned blockchain network 102 is configured to host a distributed ledger that maintains a consensually verified and immutable record of all obligations and settlements between participating entities 108A, 108B, 108C, 108D. In one or more aspects, the blockchain network 102 may be built on enterprise platforms such as Hyperledger Fabric, R3 Corda, Quorum, or similar technologies that support private transactions and configurable consensus mechanisms. Unlike public blockchains, the permissioned network restricts participation to verified entities 108A, 108B, 108C, 108D, thereby enabling higher transaction throughput and maintaining confidentiality of sensitive financial information. The network consists of nodes that may be operated by the participating entities 108A, 108B, 108C, 108D themselves or by a trusted consortium overseeing the network.

In one embodiment, the data processing and encryption module 103 handles the transformation and protection of incoming financial data. Upon receiving input data from the data interface module 101, the data processing and encryption module 103 encrypts sensitive information using institutional encryption keys specific to each participating entity 108A, 108B, 108C, 108D. The encryption process utilizes asymmetric cryptography that allows entities to decrypt only the information they are authorized to access. In specific aspect, the data processing and encryption module 103 standardizes diverse data formats into a unified structure suitable for blockchain storage and smart contract processing. In certain other aspects, the data processing and encryption module 103 also performs data validation to ensure consistency and accuracy before the information is committed to the blockchain.

In one embodiment, the smart contract suite 104 contains the core business logic that governs the multilateral netting process. The collection of programmable contracts is deployed on the blockchain network 102 and automates the entire settlement workflow. In certain aspects, the smart contracts 104 are written in platform-specific programming languages such as Solidity, Go, or Java, depending on the underlying blockchain technology. The smart contracts 104 are immutable once deployed, thereby ensuring that the settlement rules remain consistent and tamper-proof throughout the system's operation. The smart contract suite 104 includes specific contracts for participant registration, obligation recording, settlement chain identification, settlement execution, and status management.

In an embodiment, the settlement document generation module 105 creates legally valid documentation for each completed settlement. The settlement document generation module retrieves settlement details from the blockchain and generates standardized documents that comply with relevant regulatory and accounting requirements. Each document includes but not limited to participant identities, original obligation amounts, settlement amounts, remaining balances, timestamps, and unique reference identifiers. The settlement document generation module 105 may be configured to apply digital signatures from all participating entities 108A, 108B, 108C, 108D to ensure non-repudiation and legal validity. Additionally, the settlement document generation module 105 generates cryptographic hashes of these documents and records them on the blockchain to provide an immutable reference point.

In another embodiment, the user interface (UI) 106, also referred to as dashboard module, provides a visual interface for system participants 108A, 108B, 108C, 108D. The web-based application enables users to monitor their financial positions, view potential and completed settlements, and manage their participation parameters. The dashboard 106 may be configured to present analytical visualizations of settlement efficiencies, working capital improvements, and historical settlement patterns. It may also include notification capabilities that alert users to important events such as new settlement opportunities, completed settlements, or system updates. The UI 106 may further be configured to implement role-based access controls to ensure that users can only access information relevant to their organization.

In an aspect, the data interface module 101 connects directly to the data processing and encryption module 103 to form an input pipeline for the system 100. The connection is secured using TLS/SSL encryption and authenticated using API keys or mutual TLS certificates. The UI 101 triggers the processing and encryption functions when new data is submitted, therefore establishing a one-way flow of information into the system's secure environment. In one aspect, the data processing and encryption module 103 connects to the permissioned Blockchain network 102 to store the encrypted and standardized data, wherein this connection utilizes the blockchain system's native client libraries or APIs 107, authenticated using the submitting entity's cryptographic credentials. The data processing and encryption module 103 commits transactions to the blockchain that contain the encrypted obligation data, thus making it available for processing by the smart contract suite 104 while maintaining confidentiality. The permissioned blockchain network 102 connects bidirectionally with the smart contract suite 104, which is deployed within the blockchain environment itself. The smart contracts 104 are executed by the blockchain nodes according to the network's consensus mechanism. The integrated connections ensure that all contract operations benefit from the blockchain's security and immutability properties. The network 102 also provides event emission capabilities that notify other modules when significant state changes occur.

In one aspect, the smart contract suite 104 connects to the settlement document generation module 105 by triggering document creation events when settlements are executed. These events contain the settlement details required for document generation, including participant identities 108A, 108B, 108C, 108D, settled amounts, and transaction references. The connection is implemented through event listeners that monitor the blockchain for settlement completion signals. The settlement document generation module 105 connects back to the permissioned blockchain network 102 to record document hashes and metadata, thereby creating an immutable link between off-chain documents and on-chain settlement transactions, while enabling verification of document authenticity and preventing tampering. The UI 106 maintains connections to multiple other modules. It connects to the permissioned blockchain network 102 to read current state information, to the data interface module 101 to initiate new data submissions, and to the settlement document generation module 105 to retrieve and display settlement documents. These connections utilize secure API calls authenticated with user credentials, while ensuring that each participant can only access authorized information.

The detailed operational workflow of the system 100 is disclosed herein. The system 100 initiates the settlement process by receiving input data from a plurality of participating entities 108A, 108B, 108C, 108D and culminates in by settlement execution and documentation. In an exemplary aspect, during data ingestion, the participating entities 108A, 108B, 108C, 108D submit the input data to the system through the data interface module, wherein the input data includes accounts receivable and payable data. In one or more aspects, the input data includes but not limited to creditor and debtor identities, obligation amounts, currencies, due dates, and reference information. Upon receipt of the input data, the data processing and encryption module 103 encrypts the input data using institutional encryption keys and transforms it into a standardized format suitable for blockchain storage.

In accordance with an embodiment, the encrypted and standardized data is then uploaded to the permissioned blockchain network 102 through transactions initiated by the data processing and encryption module 103. The transactions are validated by the network's consensus mechanism and permanently recorded on the distributed ledger, thereby creating an immutable record of all inter-entity obligations while maintaining data confidentiality through encryption.

At predetermined intervals or when triggered by participants, the system 100 initializes a new settlement cycle. During initialization, all entities 108A, 108B, 108C, 108D and their obligations are marked as “unmatched” in the blockchain state to indicate their availability for inclusion in settlement chains. Upon identifying them as unmatched, the smart contract suite 104 then begins the process of constructing potential settlement chains. In one aspect, the system 100 utilizes settlement chain construction algorithm that iteratively builds possible settlement paths by selecting an unmatched entity and one of its unmatched outgoing obligations. The algorithm then extends the chain by identifying sequential unmatched obligations between entities 108A, 108B, 108C, 108D, continuing this process until either a complete settlement loop is formed (where the chain returns to the starting entity) or a terminal point is reached (where no further extensions are possible). This process is repeated with different starting points to identify multiple potential settlement chains.

For each constructed chain, the system 100 calculates the settlement amount, which is determined as the minimum obligation value within the chain, wherein the minimum obligation value represents the maximum amount that can be simultaneously settled across all obligations in the chain without requiring additional funds from any participant 108A, 108B, 108C, 108D. The smart contract suite 104 then executes the settlement by atomically reducing each obligation in the chain by the determined amount, such that either all obligations are updated. Following settlement execution, the smart contracts 104 update the status of all affected obligations and entities 108A, 108B, 108C, 108D. Obligations that have been reduced to zero are marked as “matched” and removed from consideration for subsequent settlement chains. Similarly, entities with no remaining unmatched obligations are marked as fully matched. Any partially settled obligations remain active with their reduced balances for potential inclusion in future settlement chains.

For each executed settlement, the settlement document generation module 105 creates legally binding documentation detailing the participating entities 108A, 108B, 108C, 108D, original obligation amounts, settled amounts, and post-settlement balances. Digital signatures from all participants 108A, 108B, 108C, 108D are collected to establish non-repudiation, and a cryptographic hash of the document is recorded on the blockchain to provide an immutable reference. The completed documents are made available to the relevant parties 108A, 108B, 108C, 108D through the UI 106 or dashboard 106. In various aspects, the system 100 then iterates through the aforementioned steps, by constructing and executing additional settlement chains until no further chains can be identified. Any remaining unmatched obligations are carried forward to the next settlement cycle, which may be initiated according to a predefined schedule or on-demand by system participants.

Throughout this process, the UI 106 or dashboard 106 provides real-time visibility into the status of obligations, potential settlement opportunities, and completed settlements. Using the dashboard 106, participants can monitor their financial positions, review settlement documentation, and analyze the efficiency gains achieved through the multilateral netting process.

In accordance with another embodiment, the entire process depicted in the blockchain account settlement architecture diagram is discussed herein. The process initiates when participating financial entities (A, B, C, and D) submit their accounts receivable and accounts payable data through the API endpoints 107 of the data interface module 101, which is the bottom layer of the architecture. The data interface module 101 validates the incoming data format, checking for completeness and correctness before accepting it. Once validated, the data flows upward to the data processing and encryption layer 103, where sensitive financial information is encrypted using institution-specific encryption keys, such that only authorized parties can access relevant information. The data processing and encryption layer 103 also standardizes the various data formats from different accounting systems into a structure suitable for blockchain storage.

The processed and encrypted data then moves to the Permissioned Blockchain Network 102 where it's organized into blocks. Historical settlement data is stored in previous blocks (N-2, N-1), while the newest financial obligations are recorded in the current block (Block N). Each block is cryptographically linked to its predecessor, creating an immutable chain of records. Within the blockchain network 102, the smart contract suite 104 automatically executes the business logic governing the settlement process. The smart contracts 104 identify potential settlement chains among the various obligations, calculate optimal settlement amounts, and execute the settlements by updating all relevant obligations in an atomic transaction.

Once settlements are executed by the smart contracts 104, the settlement document generation module 105 creates legally valid documentation recording all details of the completed settlements. The documents include participant identities, original obligation amounts, settlement amounts, timestamps, and unique reference identifiers. The settlement documents are then distributed back to all participating entities, providing legal proof of the transactions. Throughout this entire process, participants can monitor their financial positions, view potential and completed settlements, and manage their participation parameters through the dashboard interface 106, which connects to the entire system stack and provides real-time visibility into all relevant aspects of the settlement system.

In another embodiment, the system 100 implements additional privacy features using zero-knowledge proofs (ZKPs), where this configuration allows the system 100 to perform calculations and identify settlement chains without revealing the actual obligation amounts or counterparty identities to unauthorized participants. The zero-knowledge proofs enable verification that settlements are valid without exposing the underlying financial data, addressing privacy concerns for sensitive business relationships. An alternative embodiment implements partial settlement functionality, where the system 100 can construct and execute chains for portions of larger obligations. The flexibility of the present invention allows for more frequent settlements and better working capital optimization, particularly in networks with significant imbalances in obligation sizes. The partial settlement logic includes configurable minimum settlement thresholds to prevent excessive fragmentation of obligations.

An example implementation of the present invention is disclosed herein:

To illustrate the system's operation, a network with four participating entities with the following unmatched obligations is considered:
Entity A owes Entity B: $100
Entity B owes Entity C: $150
Entity C owes Entity D: $120
Entity D owes Entity A: $80

During the settlement chain construction phase, the smart contract suite identifies the closed chain A→B→C→D→A. The minimum obligation amount in this chain is $80 (from D to A), which becomes the settlement amount.

Upon settlement execution, the smart contracts atomically reduce all obligations in the chain by $80:
A owes B: $20 ($100-$80)
B owes C: $70 ($150-$80)
C owes D: $40 ($120-$80)
D owes A: $0 ($80-$80)

The obligation from D to A is fully settled and marked as matched in the blockchain state. Upon each settlement, the settlement document generation module creates a document recording the $80 multilateral netting among the four entities, collecting digital signatures from all participants, and records the document's hash on the blockchain.

In subsequent iterations, the system 100 would attempt to find additional settlement chains using the remaining unmatched balances. In this example, no further closed chains exist, so the remaining balances ($20, $70, $40) would be carried forward to the next settlement cycle.

The blockchain-based multilateral netting system 100 discussed herein provides significant advantages over existing settlement approaches. The system 100 significantly reduces payment transactions and associated costs by settling multiple obligations simultaneously without requiring the actual movement of funds between entities. The reduction in transaction volume directly translates to lower banking fees and administrative overhead for all participants. The system 100 enhances data security through institutional encryption and the permissioned blockchain architecture. Sensitive financial information remains protected while still enabling the necessary calculations for multilateral netting. The decentralized nature of the blockchain eliminates single points of failure and reduces the risk of data breaches that could expose confidential business relationships. Participating entities benefit from improved working capital efficiency by maximizing the netting potential across their entire network of business relationships rather than being limited to bilateral arrangements. The system 100 creates an immutable audit trail of all settlements on the blockchain, providing transparency and reducing disputes while simplifying regulatory compliance and reporting. By eliminating centralized intermediaries, the system 100 reduces systemic risk and dependency on third parties while increasing settlement speed. The blockchain-based system 100 distributes trust across the network while maintaining or improving security.

Alternate methods of implementation of the present invention: In an alternative embodiment, the core matching and minimum-amount settlement logic is implemented within a centralized, trusted database system rather than on a blockchain platform. In this centralized process, the system employs stored procedures or application-layer code to implement the settlement algorithms. The centralized implementation maintains an immutable audit trail through append-only logging tables that record all settlement actions. Another embodiment may enhance the privacy capabilities of the system through the implementation of Zero-Knowledge Proofs (ZKPs). In this embodiment, the system enables entities to validate settlements and verify their correctness without revealing the underlying transaction data, even to network validators or other participating entities. The implementation is valuable for industries where the existence of business relationships may be as sensitive as the financial details themselves. In another alternate embodiment, the system can be implemented with various consensus mechanisms optimized for different performance requirements and trust models among participants. In further embodiment, a hybrid implementation of the system combines on-chain settlement logic with off-chain computation for complex matching algorithms, optimizing for scalability, performance, and privacy.

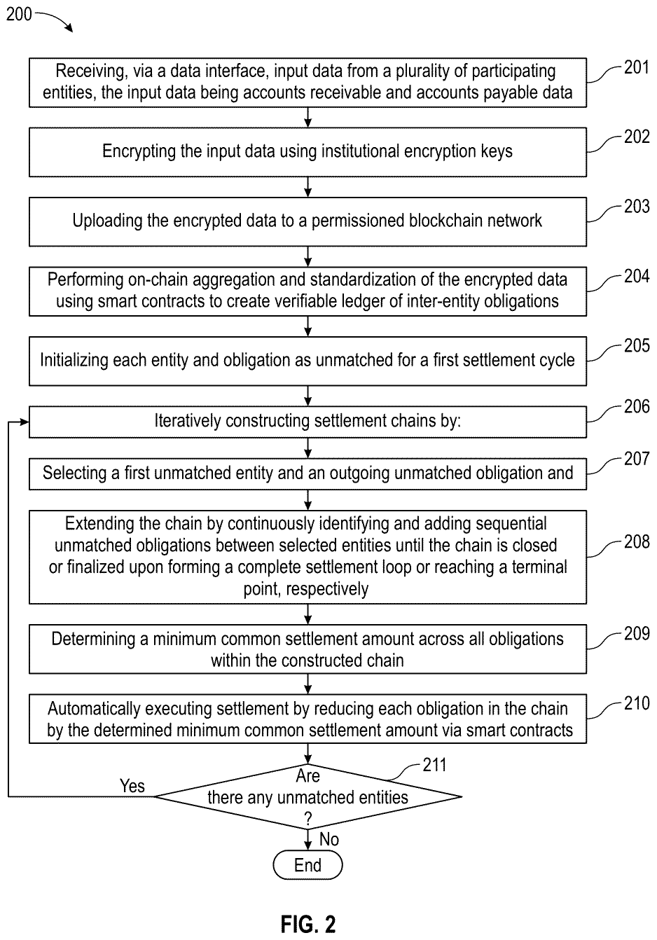

According to an exemplary embodiment, as shown in FIG. 2, a method 200 for multi-entity account settlement using a blockchain-enabled system 100 is implemented across a plurality of participating business entities is disclosed. The method initiates with the data collection phase, wherein each participating entity securely submits their accounts receivable and accounts payable data through dedicated application programming interfaces (APIs). The APIs implement standardized data formats and authentication protocols to ensure that only authorized entities can contribute data to the system. In one embodiment, the submitted data includes essential information such as creditor and debtor identities, obligation amounts, currencies, due dates, and reference information for reconciliation purposes.

The system receives 201 the submitted data and applies institutional-specific encryption to protect sensitive information. Each entity's data is encrypted 202 using their unique institutional encryption keys through asymmetric cryptography techniques, thereby ensuring that the confidentiality of business relationships and financial obligations is maintained throughout the settlement process. The data encryption helps maintain the privacy of commercially sensitive information while still enabling the system to perform the necessary calculations for multilateral netting.

The encrypted data is then uploaded 203 to a permissioned blockchain network through secure transactions. In one or more aspects, the permissioned network, which may be implemented using enterprise blockchain platforms such as Hyperledger Fabric, R3 Corda, or similar technologies, provides the distributed and immutable ledger infrastructure that forms the foundation of the settlement system. Unlike public blockchains, the permissioned network restricts participation to verified entities, thus ensuring higher transaction throughput and maintaining the confidentiality requirements of business-to-business financial operations. Once the encrypted data is recorded on the blockchain, the system performs on-chain aggregation and standardization 204 using deployed smart contracts. The smart contracts process the encrypted information, standardize diverse data formats, validate the consistency and integrity of the data, and create a verifiable ledger of inter-entity obligations. The aggregation step transforms the individual submissions into a comprehensive network view of all financial relationships for subsequent identification of efficient settlement pathways.

Prior to initiating the settlement process, the system initializes 205 the settlement cycle by marking all entities and their respective obligations as “unmatched” in the blockchain state. The initialization step ensures that all financial relationships are considered for potential inclusion in settlement chains during the current cycle. The unmatched status serves as a flag that indicates availability for processing in the settlement algorithms. The core of the settlement process involves the iterative construction 206 of settlement chains. The construction 206 involves selecting 207 a first unmatched entity from the participant pool and identifying one of its outgoing unmatched financial obligations. Further, the system extends 208 the chain by continuously identifying and adding sequential unmatched obligations between selected entities. The chain construction step/process continues until either a complete settlement loop is formed (where the final entity in the chain has an obligation to the starting entity, creating a closed circuit) or a terminal point is reached (where no further unmatched obligations can be identified to extend the chain).

For each constructed settlement chain, the system determines 209 the minimum common settlement amount. The minimum common settlement amount is calculated as the smallest obligation value within the chain and represents the maximum amount that can be simultaneously settled across all obligations in the chain without requiring additional funds from any participant. In one aspect, the calculation ensures that the settlement can be executed without requiring actual monetary transfers between entities. The system then automatically executes 210 the settlement through smart contracts deployed on the blockchain. The smart contracts atomically reduce each obligation in the identified chain by the determined minimum settlement amount. The atomic nature of the transaction ensures that either all obligations in the chain are updated simultaneously or none are, thereby eliminating counterparty risk and ensuring the integrity of the settlement process. Following the execution 210 of each settlement chain, the system identifies 211 whether any unmatched entities remain. If unmatched entities are found, the system repeats the chain construction, calculation, and execution steps to identify and process additional settlement opportunities; otherwise, the settlement process ends. The iteration continues until no further settlement chains can be formed from the remaining unmatched obligations. Any obligations that cannot be included in settlement chains during the current cycle are carried forward to subsequent settlement cycles for future processing.

Throughout this process, the system maintains an audit trail of all operations on the blockchain, for transparency and accountability while providing a legally verifiable record of all settlements. The audit trail includes the original obligation amounts, settlement amounts, remaining balances, and timestamps of all transactions, creating an immutable history of all financial interactions within the network.

In another embodiment, the method incorporates enhanced privacy and partial settlement capabilities to address specific requirements of highly regulated industries. In this implementation, the data collection phase includes additional validation steps to ensure compliance with industry-specific regulatory requirements. The APIs through which entities submit their accounts receivable and payables data implement advanced validation rules that check for compliance with relevant financial regulations, flagging any potential issues before the data enters the settlement process. The cryptographic method enables the system to identify potential settlement chains and calculate settlement amounts without exposing the actual obligation values, while providing an additional layer of privacy for sensitive financial relationships. Each entity maintains control of their encryption keys that allows only authorized parties can decrypt and view the underlying financial data.

After each settlement execution, this embodiment automatically generates legally binding settlement documents. These documents detail all aspects of the settlement, including participant identities, original obligation amounts, settled amounts, remaining balances, timestamps, and unique reference identifiers. Further, in exemplary embodiment, cryptographic hashes of these documents are recorded on the blockchain, thereby creating an immutable reference to the settlement details while maintaining the confidentiality of the underlying information. Any unmatched or partially settled obligations are carried forward to subsequent settlement cycles with updated status information. Throughout all phases of the process, the system maintains detailed event logs and audit trails on the blockchain. These records provide extensive visibility into the settlement process while respecting the privacy and confidentiality requirements of the participating entities. The immutable nature of these records ensures that they can be used for regulatory reporting, audit purposes, and dispute resolution if necessary.

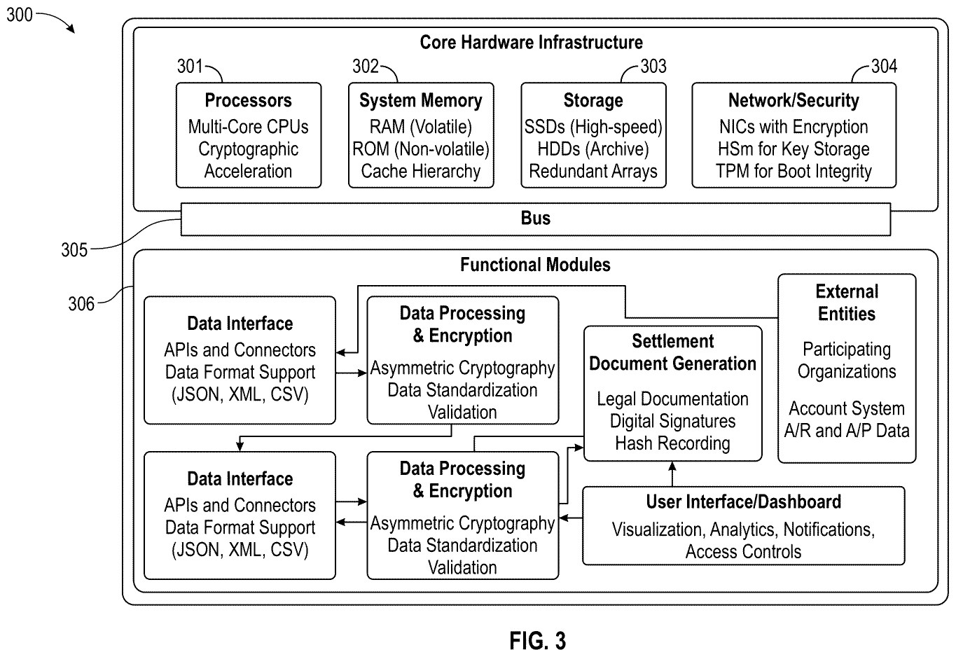

According to another exemplary embodiment, the blockchain-based system 100 for automated multi-entity account settlement is implemented using a distributed computer system. The architecture of the distributed computer system 300 is depicted in FIG. 3. The system 300 comprises one or more processors 301 communicatively coupled to a memory 302 via a bus 305. The processors 301 may include multi-core central processing units (CPUs) optimized for parallel processing of blockchain transactions and cryptographic operations. The memory 302 includes both volatile memory (such as RAM) for temporary data processing and non-volatile memory (such as ROM) containing firmware and boot instructions for system initialization. The bus 305 facilitates data transfer between the processors 301, memory 302, and other components, implementing high-throughput protocols to accommodate the substantial data movement required for blockchain operations. The system 300 further includes data storage devices 303 comprising solid-state drives (SSDs) for high-speed transaction logging and hard disk drives (HDDs) for longer-term data archiving. The storage components 303 are arranged in redundant arrays to ensure data durability and availability, with automatic failover mechanisms to prevent data loss during hardware failures.

The system 300 incorporates network interface controllers (NICs) 304 connected to the bus 305, supporting high-bandwidth, low-latency communication between distributed nodes in the permissioned blockchain network. The NICs 304 implement hardware acceleration for encryption protocols, reducing computational overhead on the main processors during secure communications. The network infrastructure 304 includes redundant connection paths and load balancing mechanisms to distribute traffic efficiently across the blockchain network. A hardware security module (HSM) is integrated into the system 300 to provide secure key storage for the institutional encryption keys utilized by the data processing and encryption module. The HSM connects directly to the bus 305 and provides hardware-accelerated cryptographic functions, including asymmetric encryption, digital signature generation, and verification operations essential for the secure operation of the blockchain network.

The functional modules 306, including data interface module, a permissioned blockchain network, a data processing and encryption module, a smart contract suite, a settlement document generation module, and a user interface/dashboard module communicate with the hardware infrastructure through the bus 305, which facilitates secure data transfer between processors 301, memory 302, and storage devices 303 while enforcing appropriate access controls. The data interface module is implemented as a software component running on application servers with processors optimized for handling concurrent API requests. These servers connect to the main system through secured network channels and utilize local memory caches to improve performance during data ingestion operations. The permissioned blockchain network is deployed across multiple physical and virtual machines, each equipped with processors specifically configured for consensus algorithm execution and transaction validation.

The data processing and encryption module 307 executes on servers with cryptographic acceleration hardware, thereby enabling efficient encryption and decryption of large volumes of financial data. The servers include expanded memory configurations to accommodate in-memory processing of data transformations before blockchain commitment. A smart contract suite operates within the execution environment of the blockchain nodes, by utilizing the processing capabilities of each node's hardware. Additional compute resources are allocated to nodes responsible for contract execution to ensure responsive settlement processing.

Further, the user interface or dashboard module is hosted on web application servers with dedicated graphics processing capabilities for rendering analytical visualizations. These servers maintain secured connections to the core system components through application gateways that enforce access controls and validate all user requests against permission policies stored in the system's identity management subsystem.

It will finally be understood that the disclosed embodiments are presently preferred examples of how to make and use the claimed invention, and are intended to be explanatory rather than limiting the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

1. A method for multi-entity account settlement using a blockchain-enabled system, the method comprising:
receiving, via a data interface, input data from a plurality of participating entities, the input data being accounts receivable and accounts payable data;
encrypting the input data using institutional encryption keys specific to each participating entity, wherein the encryption utilizes asymmetric cryptography to ensure that each entity can decrypt only information it is authorized to access;
uploading the encrypted data to a permissioned blockchain network that restricts participation to verified entities and maintains a consensually verified and immutable distributed ledger of all obligations and settlements;
performing on-chain aggregation and standardization of the encrypted data using smart contracts to create verifiable ledger of inter-entity obligations;
initializing each entity and obligation as unmatched for a first settlement cycle;
iteratively constructing settlement chains by:
selecting a first unmatched entity and an outgoing unmatched obligation; and
extending the chain by continuously and non-duplicatively identifying and adding sequential unmatched obligations between selected entities until the chain is closed or finalized upon forming a complete settlement loop or reaching a terminal point, respectively;
determining a minimum common settlement amount across all obligations within the constructed chain, wherein the minimum common settlement amount is calculated as the smallest obligation value within the chain and represents the maximum amount that can be simultaneously settled across all obligations in the chain without requiring actual monetary transfer from any participant;
automatically executing settlement by reducing each obligation in the chain by the determined minimum common settlement amount via smart contracts, wherein the smart contracts atomically reduce each obligation such that all obligations in the chain are updated simultaneously or none are, thereby eliminating counterparty risk; and
repeating steps from settlement chain construction to settlement execution until no further chains can be formed.

2. The method of claim 1, further comprising marking obligations and entities as matched where balances are reduced to zero.

3. The method of claim 1, further comprising automatically generating a legally binding settlement document for each settled chain.

4. The method of claim 3, further comprising recording a hash of the settlement document immutably on the blockchain.

5. The method of claim 1, further comprising carrying forward any unmatched obligations to a next settlement cycle.

6. The method of claim 1, wherein the input data are received via one or more application programming interface (APIs).

7. The method of claim 1, wherein the blockchain network is a permissioned blockchain selected from Hyperledger Fabric and R3 Corda.

8. The method of claim 1, wherein the smart contracts are configured to automatically aggregate balances, construct settlement chains, execute settlements, and update obligation statuses.

9. The method of claim 1, wherein the settlement document comprises details of the participant entities, settled amounts, and post-settlement obligation balances.

10. The method of claim 1, wherein the settlement execution is performed without movement of actual monetary funds between entities.

11. A system comprising a processor and memory, wherein the processor and memory in combination are operable to implement a method comprising:
receiving, via a data interface, input data from a plurality of participating entities, the input data being accounts receivable and accounts payable data;
encrypting the input data using institutional encryption keys specific to each participating entity, wherein the encryption utilizes asymmetric cryptography to ensure that each entity can decrypt only information it is authorized to access;
uploading the encrypted data to a permissioned blockchain network that restricts participation to verified entities and maintains a consensually verified and immutable distributed ledger of all obligations and settlements;
performing on-chain aggregation and standardization of the encrypted data using smart contracts to create verifiable ledger of inter-entity obligations;
initializing each entity and obligation as unmatched for a first settlement cycle;
iteratively constructing settlement chains by:
selecting a first unmatched entity and an outgoing unmatched obligation; and
extending the chain by continuously and non-duplicatively identifying and adding sequential unmatched obligations between selected entities until the chain is closed or finalized upon forming a complete settlement loop or reaching a terminal point, respectively;
determining a minimum common settlement amount across all obligations within the constructed chain, wherein the minimum common settlement amount is calculated as the smallest obligation value within the chain and represents the maximum amount that can be simultaneously settled across all obligations in the chain without requiring actual monetary transfer from any participant;
automatically executing settlement by reducing each obligation in the chain by the determined minimum common settlement amount via smart contracts, wherein the smart contracts atomically reduce each obligation such that all obligations in the chain are updated simultaneously or none are, thereby eliminating counterpart risk; and
repeating steps from settlement chain construction to settlement execution until no further chains can be formed.

12. The system of claim 11, further comprising marking obligations and entities as matched where balances are reduced to zero.

13. The system of claim 11, further comprising automatically generating a legally binding settlement document for each settled chain.

14. The system of claim 13, further comprising recording a hash of the settlement document immutably on the blockchain.

15. The system of claim 11, further comprising carrying forward any unmatched obligations to a next settlement cycle.

16. The system of claim 11, wherein the input data are received via one or more application programming interface (APIs).

17. The system of claim 11, wherein the blockchain network is a permissioned blockchain selected from Hyperledger Fabric and R3 Corda.

18. The system of claim 11, wherein the smart contracts are configured to automatically aggregate balances, construct settlement chains, execute settlements, and update obligation statuses.

19. The system of claim 11, wherein the settlement document comprises details of the participant entities, settled amounts, and post-settlement obligation balances.

20. The system of claim 11, wherein the settlement execution is performed without movement of actual monetary funds between entities.
